(19) United States
(12) Patent Application Publication
(10) Pub. No.: US 2015/0263358 A1
(43) Pub. Date: Sep. 17, 2015

(54) FLOW BATTERY WITH MIXED FLOW

(71) Applicant: UNITED TECHNOLOGIES CORPORATION, Hartford, CT (US)

(72) Inventors: Rachid Zaffou, West Hartford, CT (US); Arun Pandy, Manchester, CT (US); Michael L. Perry, Glastonbury, CT (US)

(21) Appl. No.: 14/364,712

(22) PCT Filed: Dec. 20, 2011
(86) PCT No.: PCT/US2011/066143

§ 371 Date: Jan. 12, 2015

(51) Int. Cl. H01M 8/02; H01M 8/20; H01M 8/18

(52) U.S. Cl. CPC H01M 8/0263; H01M 8/026; H01M 8/188; H01M 8/20

(57) ABSTRACT

A flow battery includes a liquid electrolyte that has an electrochemically active specie and a bipolar plate that has channels for receiving flow of the liquid electrolyte. A porous electrode is arranged immediately adjacent the bipolar plate. The porous electrode is catalytically active with regard to the liquid electrolyte. The channels of the bipolar plate have at least one of a channel arrangement or a channel shape that is configured to positively force at least a portion of the flow of the liquid electrolyte into the porous electrode.

### BACKGROUND

This disclosure relates to flow batteries for selectively storing and discharging electric energy.

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

A basic flow battery includes a redox flow cell that has a negative electrode and a positive electrode separated by an electrolyte layer, which may include separator such as an ion-exchange membrane. A negative liquid electrolyte is delivered to the negative electrode and a positive liquid electrolyte is delivered to the positive electrode to drive electrochemically reversible redox reactions. Upon charging, the electrical energy supplied causes a chemical reduction reaction in one electrolyte and an oxidation reaction in the other electrolyte. The separator prevents the electrolytes from mixing but permits selected ions to pass through to complete the redox reactions. Upon discharge, the chemical energy contained in the liquid electrolytes is released in the reverse reactions and electrical energy can be drawn from the electrodes. Flow batteries are distinguished from other electrochemical devices by, inter alia, the use of externally-supplied, liquid electrolytes that participate in a reversible electrochemical reaction.

### SUMMARY

Disclosed is a flow battery that includes a liquid electrolyte that has an electrochemically active specie and a bipolar plate that has channels for receiving flow of the liquid electrolyte. A porous electrode is arranged immediately adjacent the bipolar plate. The porous electrode is catalytically active with regard to the liquid electrolyte. The channels of the bipolar plate have at least one of a channel arrangement or a channel shape that is configured to positively force at least a portion of the flow of the liquid electrolyte into the porous electrode.

In an example, the channel arrangement includes a first channel and a second, adjacent channel separated from the first channel by a rib to positively force at least a portion of the flow of the liquid electrolyte into the porous electrode. In another example, the channel shape has a cross-sectional area that varies over the length of the channel to positively force at least a portion of the flow of the liquid electrolyte into the porous electrode.

Also disclosed is a method of operation that includes positively forcing at least a portion of a flow of a liquid electrolyte into a porous electrode.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 shows an example flow battery.

FIG. 2 shows an example cell of the flow battery of FIG. 1.

FIG. 3A shows a channel of a bipolar plate which increases in cross-sectional area from a channel inlet to a channel outlet.

FIG. 3B shows a channel of a bipolar plate which decreases in cross-sectional area from a channel inlet to a channel outlet.

FIG. 4A shows a section taken at a channel inlet of an interdigitated channel arrangement.

FIG. 4B shows a section taken at a channel outlet of an interdigitated channel arrangement.

FIG. 5A shows a cross-section of a channel of a bipolar plate which includes protrusions.

FIG. 5B shows a top view of the channel of FIG. 5A.

FIG. 6 shows a serpentine channel arrangement.

FIG. 7 illustrates a linear channel arrangement.

FIG. 8 shows a cross-section of a channel with a predetermined ratio of a width dimension to a depth dimension for positively forcing flow of a liquid electrolyte in an adjacent porous electrode.

### DETAILED DESCRIPTION OF THE PREFERRED EMBODIMENT

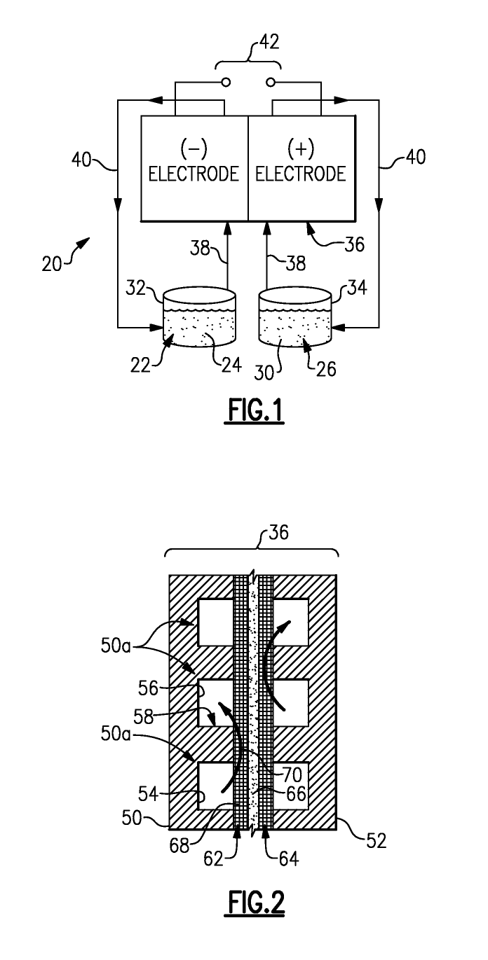

FIG. 1 illustrates selected portions of an example flow battery 20 for selectively storing and discharging electrical energy. As an example, the flow battery 20 may be used to convert electrical energy generated in a renewable energy system to chemical energy that is stored until a later time when there is greater demand at which the flow battery 20 then converts the chemical energy back into electrical energy. The flow battery 20 may supply the electric energy to an electric grid, for example. As will be described, the disclosed flow battery 20 includes features for enhanced performance.

The flow battery 20 includes a liquid electrolyte 22 that has an electrochemically active specie 24 that functions in a redox pair with regard to an additional liquid electrolyte 26 and electrochemically active specie 30. For example, the electrochemically active species 24 and 30 are based on vanadium, bromine, iron, chromium, zinc, cerium, lead or combinations thereof. In embodiments, the liquid electrolytes 22 and 26 are aqueous solutions that include one or more of the electrochemically active species 24 and 30.

The liquid electrolytes 22 and 26 are contained in respective storage tanks 32 and 34. As shown, the storage tanks 32 and 34 are substantially equivalent cylindrical storage tanks; however, the storage tanks 32 and 34 can alternatively have other shapes and sizes.

The liquid electrolytes 22 and 26 are delivered (e.g., pumped) to one or more cells 36 of the flow battery 20 through respective feed lines 38 and are returned from the cell or cells 36 to the storage tanks 32 and 34 via return lines 40.

In operation, the liquid electrolytes 22 and 26 are delivered to the cell 36 to either convert electrical energy into chemical energy or convert chemical energy into electrical energy that can be discharged. The electrical energy is transmitted to and from the cell 36 through an electrical pathway 42 that completes the circuit and allows the completion of the electrochemical redox reactions.

FIG. 2 shows a cross-section of a portion of one of the cells 36. It is to be understood that the flow battery 20 can include a plurality of such cells 36 in a stack, depending on the designed capacity of the flow battery 20. As shown, the cell 36 includes a first bipolar plate 50 and a second bipolar plate 52 spaced apart from the first bipolar plate 50. The bipolar plates 50 and 52 are electrically conductive and can be graphite plates or metallic plates, for example.

The first bipolar plate 50 includes a plurality of channels 50a, which include a first channel 54 and a second, adjacent channel 56 that is separated from the first channel 54 by a rib 58. In this example, the configuration of the second bipolar plate 52 is substantially similar to the first bipolar plate 50, although it is conceivable that the second bipolar plate 52 could alternatively have a dissimilar configuration.

Porous electrodes 62 and 64 are arranged immediately adjacent the respective first and second bipolar plates 50 and 52. Thus, the porous electrode 62 is in contact with the face of the first bipolar plate 50 and the porous electrode 64 is in contact with the face of the second bipolar plate 52. A separator, such as an ion-exchange membrane, 66 is arranged between the porous electrodes 62 and 64.

The porous electrodes 62 and 64 are composed of material that is electrically conductive, relatively corrosion resistant, and catalytically active with regard to the electrochemical specie. In one example, one or both of the porous electrodes 62 and 64 include a carbon paper 68, such as carbon fiber paper, that is catalytically active with regard to the liquid electrolyte 22 and/or 26. That is, the surfaces of the carbon material of the carbon paper 68 are catalytically active in the flow battery 20. In the redox reactions of the flow battery 20, the energy barrier to the reaction is relatively low, and thus stronger catalytic materials, such as noble metals or alloys, are not required as with electrochemical devices that utilize gaseous reactants, such as oxygen or hydrogen. In one embodiment, the carbon paper 68 is activated using a prior thermal and/or chemical treatment process to clean the carbon material and produce carbon surfaces that serve as improved active catalytic sites.

There is a tradeoff in flow batteries between performance and pressure drop of the flow of the liquid electrolytes through a cell. For example, a flow battery may not utilize flow fields. In such a design, the liquid electrolytes flow entirely through porous electrodes from end to end. This type of design provides either relatively poor performance with acceptable pressure drop because the electrodes are relatively thick to accommodate all of the flow through the porous media; or, relatively good performance but high pressure drop because the electrodes are thinner and the flow resistance through the entire porous electrode is relatively high (which increases the parasitic loads in order to move the electrolyte through the cell) and relatively low durability because of stack compression on the electrodes and ion-exchange membrane. In comparison, another type of flow battery may utilize flow field channels. In such a design, the liquid electrolytes flow through the channels and diffuse into the adjacent electrodes. This type of design provides less of a pressure drop because the liquid electrolytes flow relatively unrestricted through the channels and the electrodes can be thinner, but the performance is relatively poor because of the relatively steep concentration gradients in the electrodes (necessary to promote a high rate of diffusive transport) and non-uniform diffusion of the electrolytes into the electrodes. What is needed are cell designs that can use relatively thin electrodes with forced convective flow and still enable acceptable pressure drops across the cells.

As will be described, the channels 50a of the bipolar plate 50 of the flow battery 20 have at least one of a channel arrangement or a channel shape that is configured to positively force at least a portion of the flow 70 of the liquid electrolyte 22 into the porous electrode 62. The term “positively forcing” or forced convective flow or variations thereof refers to the structure of the bipolar plate 50 being configured to move the liquid electrolyte 22 from the channels 50a into the porous electrode 62 by the mechanism of a pressure gradient. In comparison, diffusion is a concentration-driven mechanism. The bipolar plate 50 thereby provides a “mixed flow” design that is a combination of the positively forced flow 70 through the electrode 62 and flow through the channels 50a to achieve a desirable balance between pressure drop and performance.

It is to be appreciated that the bipolar plate 50 can have a variety of channel arrangements and/or a channel shapes that are configured to positively force at least a portion of the flow 70 of the liquid electrolyte 22 into the porous electrode 62. The following are non-limiting examples of such channel arrangements and/or a channel shapes.

In the example shown in FIG. 2, the channel 56 is located downstream from the channel 54, and thus the liquid electrolyte 22 flowing in the channel 56 is at a lower pressure than the liquid electrolyte 22 flowing in the channel 54 due to pressure losses. The difference in pressure causes a pressure gradient between the channels 54 and 56 that positively forces at least a portion of the liquid electrolyte 22 to flow over the rib 58 from the channel 54 into the channel 56. In some examples, the channels 54 and 56 are channels of a serpentine channel arrangement, interdigitated channel arrangement, partially interdigitated channel arrangement or combination thereof to provide the pressure gradient.

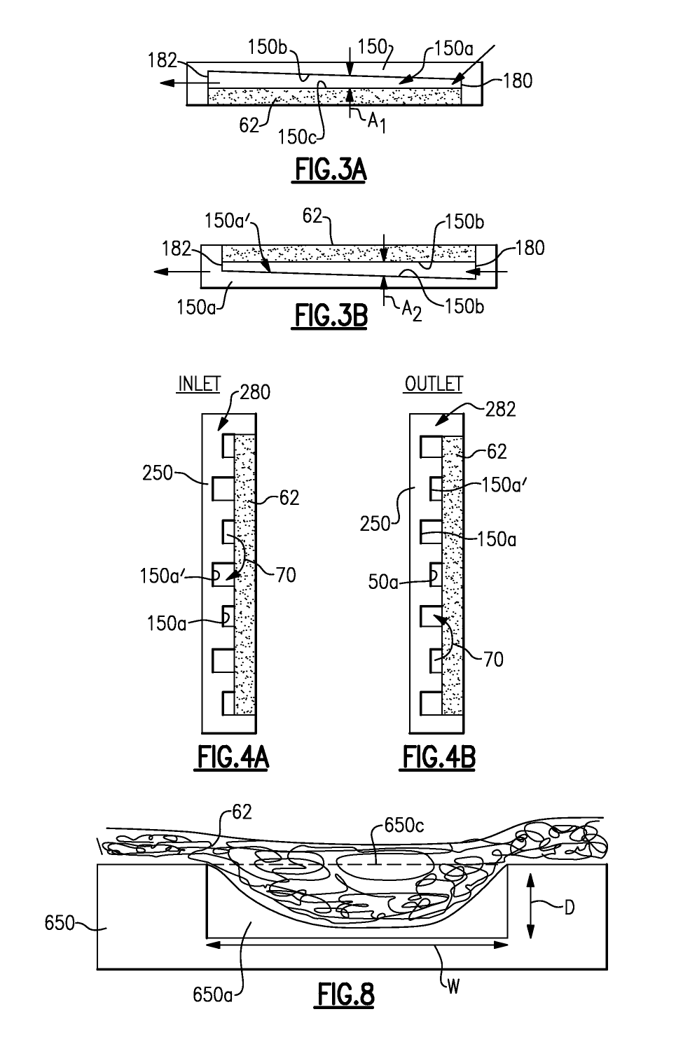

FIG. 3A shows an example channel shape of a channel 150a of a bipolar plate 150 that is configured to positively force at least a portion of the flow of the liquid electrolyte 22 into the porous electrodes 62. In this disclosure, like reference numerals designate like elements where appropriate and reference numerals with the addition of one-hundred or multiples thereof designate modified elements that are understood to incorporate the same features and benefits of the corresponding elements. As shown, the channel 150a extends over a length between a channel inlet 180 and a channel outlet 182. In an example, the channel outlet 180 is an orifice that opens to a common manifold that serves to deliver liquid electrolyte 22 into the channels 150a. Similarly, the channel outlet 182 is an orifice that opens to a common manifold that serves to deliver the liquid electrolyte 22 back to the return line 40 and storage tank 32.

In this example, the channel 150a defines a cross-sectional area A₁ that extends between side walls (not shown), a bottom 150b of the channel 150a and an open top 150c of the channel 150a. The porous electrode 62 is arranged adjacent to the open top 150c. As shown, the cross-sectional area A₁ varies along the length of the channel 150a from the channel inlet 180 to the channel outlet 182. In this example, the bottom 150b of the channel 150a is sloped such that the cross-sectional area A₁ increases from the channel inlet 180 to the channel outlet 182. Alternatively, or in addition to the sloped bottom 150b, the side walls are sloped to vary A₁.

In operation, the liquid electrolyte 22 is at a higher pressure in the narrower portion of the channel 150a, which positively forces the liquid electrolyte 22 to flow into the adjacent porous electrode 62.

FIG. 3B shows another example channel 150a′ in which the bottom 150b slopes the other way such that a cross-sectional area A₂ decreases from the channel inlet 180 to the channel outlet 182.

FIG. 4A shows a cross-sectional view taken at a channel inlet 280 of a bipolar plate 250, and FIG. 4B shows a cross-sectional view of the bipolar plate 250 taken at a channel outlet 282. In this example, the bipolar plate 250 includes first channels 150a and second channels 150a′, as described above with regard to FIGS. 3A and 3B. The first channels 150a are interdigitated with the second channels 150a′.

In operation, the channel shapes and interdigitated channel arrangement provide a pressure gradient between adjacent channels 150 and 150a′ that positively forces flow 70 of the liquid electrolyte 22 into the porous electrode 62. The cross-sectional area variations can be designed to obtain the amount of forced flow through the porous electrode desired. The extreme case is to make the inlet cross-sectional areas of every other channel zero, such that all of the electrolyte must pass through the porous electrode in order to exit the cell.

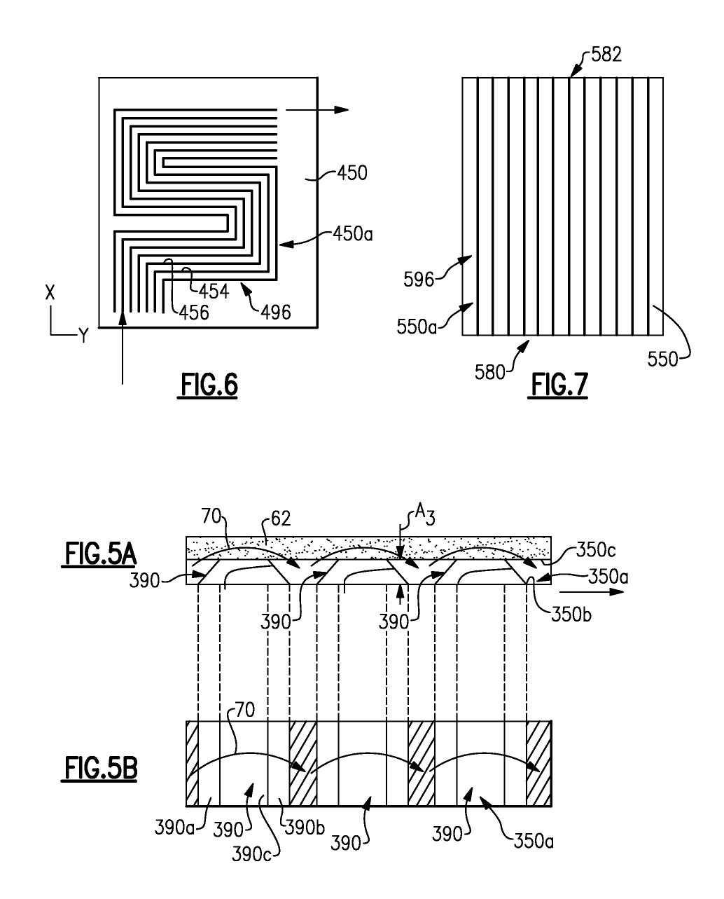

FIG. 5A shows another example channel 350a which has a cross-sectional area A₃ that varies along the length of the channel 350a. The channel 350a includes a plurality of protrusions 390 that extend from a bottom 350b of the channel 350a toward an open top 350c of the channel 350a and between the side walls of the channel 350a.

In the illustrated example, each of the protrusions 390 provides a change in the cross-sectional area A₃ as a function of length along the channel 350a. In operation, as the liquid electrolyte 22 flows through the channel 350a and encounters the protrusions 390, the flow 70 of the liquid electrolyte 22 is positively forced over the protrusion 390 and into the adjacent porous electrode 62. Thus, each of the protrusions 390 effectively increases the local pressure of the liquid electrolyte 22 to positively force it into the porous electrode 62. The valleys between the protrusions 390 likewise effectively reduce the local pressure such that the liquid electrolyte 22 flows back into the channel 350a from the porous electrode 62.

FIG. 5B shows a top view of the channel 350a and protrusions 390. In this example, each of the protrusions 390 includes sloped sidewalls 390a and 390b that are transversely sloped with regard to the plane of the bottom 350b of the channel 350a. The sloped sidewalls 390a and 390b terminate at a top surface 390c. Thus, the flowing liquid electrolyte 22 first encounters the transversely sloped sidewall 390a which gradually increases the pressure of the liquid electrolyte 22 to a maximum pressure over the top 390c. Similarly, the second transversely sloped sidewall 390b gradually reduces the pressure of the flowing liquid electrolyte 22 to the bottom 350b.

FIG. 6 shows bipolar plate 450 that has a serpentine channel arrangement 496 that positively forces at least a portion of the flow of the liquid electrolyte 22 into the adjacent porous electrode 62. The driving force for the flow through the porous electrode in this case is due to the difference in pressure between adjacent channels at different distances from the common inlet due to the serpentine arrangement. The serpentine channel arrangement 496 includes a plurality of channels 450a, including a first channel 454 and a second, adjacent channel 456 that are separated by a rib (not shown) as described above. The channels 450a include portions that extend in an X-direction and other portions that extend in a Y-direction back and forth over the bipolar plate 450. A serpentine arrangement with less channels will promote more forced flow through the electrode, with the extreme case being a single serpentine channel. Alternatively, a cell may incorporate multiple serpentine channels where each channel transverses a limited X and Y region of the plate (not shown).

FIG. 7 shows another example bipolar plate 550 that has channel arrangement 596 of channels 550a. In this example, the channels 550a extend linearly between a channel inlet 580 and a channel outlet 582. The individual channels 550a are tapered as shown in FIGS. 3A and 3B or alternatively include protrusions 390 as shown in FIGS. 5A and 5B. These channels could also be tapered in a manner analogous to FIGS. 3A and 3B except that the channels vary in channel width instead of channel depth as shown in FIGS. 3A and 3B.

FIG. 8 shows a portion of another example bipolar plate 650 having a channel 650a that is representative of a plurality of such channels in the bipolar plate 650. In this example, the channel 650a has a uniform cross-sectional area and extends between a channel inlet and a channel outlet, as previously described. The channel 650a also has a width dimension W that extends between sidewalls of the channel 650a and a depth dimension D that extends between a bottom 650b and an open top 650c. The width dimension W and the depth dimension D are selected to positively force the flow of liquid electrolyte 22 into the adjacent porous electrode 62. For example, the width dimension W and depth dimension D are selected to be within a ratio of W:D. In one example, the ratio W:D is from 1.5:1 to 3:1. The given ratio provides that the channel 650a is wider than it is deep. Thus, the adjacent porous electrode 62 tends to “tent” into the channel 650a. The tenting of the porous electrode 62 into the channel 650a reduces the open volume of the channel 650a and thereby increases the pressure of the liquid electrolyte 22. The increased pressure positively forces the liquid electrolyte to flow into the porous electrode 62.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A flow battery comprising:
a liquid electrolyte including an electrochemically active specie;
a bipolar plate including channels for receiving flow of the liquid electrolyte; and
a porous electrode immediately adjacent the bipolar plate, the porous electrode being catalytically active with regard to the liquid electrolyte, and
wherein the channels of the bipolar plate have at least one of a channel arrangement or a channel shape that is configured to positively force at least a portion of the flow of the liquid electrolyte into the porous electrode.

2. The flow battery as recited in claim 1, wherein the channel arrangement includes a first channel and a second, adjacent channel separated from the first channel by a rib.

3. The flow battery as recited in claim 1, wherein the channels have a serpentine channel arrangement.

4. The flow battery as recited in claim 1, wherein the channel shape defines a cross-sectional area that decreases from a channel inlet to a channel outlet.

5. The flow battery as recited in claim 1, wherein the channel shape defines a cross-sectional area that increases from a channel inlet to a channel outlet.

6. The flow battery as recited in claim 1, wherein the channels include first channels that each have a cross-sectional area that increases from a channel inlet to a channel outlet and second channels that each have a cross-sectional area that decreases from the channel inlet to the channel outlet, and the first channels are interdigitated with the second channels.

7. The flow battery as recited in claim 1, wherein each of the channels has a width extending between side walls and a depth extending between a bottom wall and an open top, and the channel shape includes a plurality of protrusions that extend from the bottom wall toward the open top.

8. The flow battery as recited in claim 7, wherein each of the plurality of protrusions extends from one of the side walls to the other of the side walls.

9. The flow battery as recited in claim 1, wherein each of the channels has a uniform cross-sectional area along its length, a width dimension (W) extending between side walls and a depth dimension (D) extending between a bottom wall and an open top, and wherein a scalable ratio W:D is from 1.5:1 to 3:1.

10. A flow battery comprising:
a liquid electrolyte including an electrochemically active specie;
a bipolar plate including channels for receiving flow of the liquid electrolyte; and
a porous electrode immediately adjacent the bipolar plate, the porous electrode being catalytically active with regard to the liquid electrolyte, and
wherein the channels of the bipolar plate have at least one of the following features to positively force at least a portion of the flow of the liquid electrolyte into the porous electrode:
a channel arrangement including a first channel and a second, adjacent channel separated from the first channel by a rib, and
a channel shape having a cross-sectional area that varies over the length of the channel.

11. A method of operating a flow battery, the method comprising:
providing a bipolar plate including channels and a porous electrode immediately adjacent the bipolar plate;
establishing a flow of a liquid electrolyte in the channels, the liquid electrolyte including an electrochemically active specie and the porous electrode being catalytically active with regard to the liquid electrolyte; and
positively forcing at least a portion of the flow of the liquid electrolyte from the channels into the porous electrode.

12. The method as recited in claim 11, including positively forcing the at least a portion of the flow by establishing a pressure gradient between a first channel and a second, adjacent channel to force the at least a portion of the flow over a rib between the first channel and the second channel.

13. The method as recited in claim 11, including using a serpentine channel arrangement to positively force the at least a portion of the flow of the liquid electrolyte from the channels into the porous electrode.

14. The method as recited in claim 11, including using a channel shape that has a cross-sectional area that decreases from a channel inlet to a channel outlet to positively force the at least a portion of the flow of the liquid electrolyte from the channels into the porous electrode.

15. The method as recited in claim 11, including using a channel shape that has a cross-sectional area that increases from a channel inlet to a channel outlet to positively force the at least a portion of the flow of the liquid electrolyte from the channels into the porous electrode.

16. The method as recited in claim 11, including using a channel arrangement that has first channels that are interdigitated with second channels to positively force the at least a portion of the flow of the liquid electrolyte from the channels into the porous electrode, the first channels each having a cross-sectional area that increases from a channel inlet to a channel outlet and the second channels each having a cross-sectional area that decreases from the channel inlet to the channel outlet.

17. The method as recited in claim 11, including using a channel shape that has a width extending between side walls, a depth extending between a bottom wall and an open top and a plurality of protrusions extending from the bottom wall toward the open top to positively force the at least a portion of the flow of the liquid electrolyte from the channels into the porous electrode.

18. The method as recited in claim 11, wherein each channel has a uniform cross-sectional area along its length, a width dimension (W) extending between side walls and a depth dimension (D) extending between a bottom wall and an open top, and including using a scalable ratio W:D that is from 1.5:1 to 3:1 to positively force the at least a portion of the flow of the liquid electrolyte from the channels into the porous electrode.
